(19) United States
(12) Patent Application Publication
(10) Pub. No.: US 2017/0279820 A1
(43) Pub. Date: Sep. 28, 2017

(54) SYSTEM AND METHOD FOR DETECTING COMPUTER ATTACKS

(71) Applicant: Charles Dale Herring, Elmhurst, IL (US)

(72) Inventor: Charles Dale Herring, Elmhurst, IL (US)

(21) Appl. No.: 15/416,025

(22) Filed: Jan. 26, 2017

Related U.S. Application Data
(60) Provisional application No. 62/312,916, filed on Mar. 24, 2016.

(51) Int. Cl. H04L 29/06; G06F 17/30

(52) U.S. Cl. CPC H04L 63/1416; H04L 63/02; G06F 17/30477

(57) ABSTRACT

One embodiment of the invention is a system that stores a characteristic “modus operandi” for each type of computer attack that has historically been encountered or that could potentially be encountered on a computer network. In this embodiment, the system uses criteria derived from a modus operandi to query an event data store, identifying entities (host computers, user credentials, or malicious software objects) on the network that meet those criteria. The system also queries a flow data store to identify network connections among the identified entities that meet the criteria for the modus operandi. The identified entities and network connections are then analyzed to determine whether an attack matching the modus operandi is underway. If so, the system transmits a notification to permit the attack to be thwarted before it is completed (i.e., before exfiltration of sensitive stolen data occurs).

### CROSS-REFERENCE TO RELATED APPLICATIONS

This application claims the benefit of priority under 35 U.S.C. §119(e) of U.S. Provisional Patent Application No. 62/312,916, “Computer Software to Detect Computer Attacks,” filed on Mar. 24, 2016, the content of which is herein incorporated by reference in its entirety and for all purposes.

### BACKGROUND OF THE INVENTION

The present invention relates to computer networks and, more particularly, to systems and methods for detecting computer attacks carried out by cyber criminals over computer networks.

Some types of computer attacks occur in phases over a period of time. For example, an attacker might send, to employees of an enterprise, an e-mail containing a hyperlink. When an employee clicks on the hyperlink, a malicious software application is installed on the employee's computer without the employee's knowledge. That malicious software application then permits the attacker to gain control of the employee's computer remotely. The attacker uses that access to a machine inside the enterprise's network to gather information about other computers on the network. In a subsequent phase, the attacker uses a computer on the enterprise's network as a staging host to collect sensitive data (e.g., data from the enterprise's data center). In a final phase, the attacker uses another computer on the enterprise's network, typically a Web server, to “exfiltrate” the stolen data outside of the enterprise's network to the attacker's domain. That is, the attacker uses a computer on the enterprise's network to transmit the stolen data to a computer controlled by the attacker.

Conventional computer security platforms have not been very effective in detecting attacks like that described above. These prior-art systems trigger investigations of potential attacks at the event level (e.g., “a virus has been detected on Computer A”). Such an event-driven approach results in a large number of investigations, and the time needed to complete all of those investigations can render attack detection cumbersome and inefficient.

It is apparent that there is a need in the art for improved systems and methods for detecting computer attacks.

### SUMMARY OF THE INVENTION

One aspect of the present invention is a system for detecting computer attacks, comprising at least one processor; at least one memory; at least one communication interface for communicating over a network; and a plurality of program instructions stored in the at least one memory that, when executed by the at least one processor, cause the at least one processor to load into the at least one memory criteria for at least one modus operandi, each modus operandi corresponding to a particular attack scenario; query an event data store to identify entities on the network that meet the criteria for the at least one modus operandi; query a flow data store to identify network connections among the identified entities that meet the criteria for the at least one modus operandi; analyze the identified entities and the identified network connections to determine whether an attack matching the at least one modus operandi is underway; and transmit a notification over the network, if it is determined that an attack matching the at least one modus operandi is underway.

Another aspect of the present invention is a method for detecting computer attacks, comprising loading into a computer memory criteria for at least one modus operandi, each modus operandi corresponding to a particular attack scenario; querying an event data store over a network to identify entities on the network that meet the criteria for the at least one modus operandi; querying a flow data store over the network to identify network connections among the identified entities that meet the criteria for the at least one modus operandi; analyzing the identified entities and the identified network connections to determine whether an attack matching the at least one modus operandi is underway; and transmitting a notification over the network, if it is determined that an attack matching the at least one modus operandi is underway.

These and other features, aspects, and advantages of the present invention will become better understood with reference to the following drawings, description, and claims.

### BRIEF DESCRIPTION OF THE DRAWINGS

FIG. 1 is a functional block diagram of a system for detecting computer attacks in accordance with an illustrative embodiment of the invention;

FIG. 2 is a flowchart of a method for detecting computer attacks in accordance with an illustrative embodiment of the invention; and

FIG. 3 is an illustrative diagram of a computer attack of a type that can be detected by various embodiments of the invention.

### DETAILED DESCRIPTION OF THE INVENTION

The following Detailed Description is of the best currently contemplated modes of carrying out illustrative embodiments of the invention. The description is not to be taken in a limiting sense but is made merely for the purpose of illustrating the general principles of the invention, since the scope of the invention is best defined by the appended claims.

One embodiment of the invention is a system that stores a characteristic “modus operandi” for each type of computer attack that has historically been encountered or that could potentially be encountered over a computer network. In this embodiment, the system uses criteria derived from a modus operandi to query an event data store, identifying entities (host computers, user credentials, or malicious software objects) on the network that meet those criteria. The system also queries a flow data store to identify network connections among the identified entities that meet the criteria for the modus operandi. The identified entities and network connections are then analyzed to determine whether an attack matching the modus operandi is underway. If so, the system transmits a notification to permit the attack to be thwarted before it is completed (i.e., before exfiltration of sensitive stolen data occurs). In some embodiments, the notification is sent to a user's (e.g., network administrator's) Web browser. In other embodiments, the notification is sent to a network firewall.

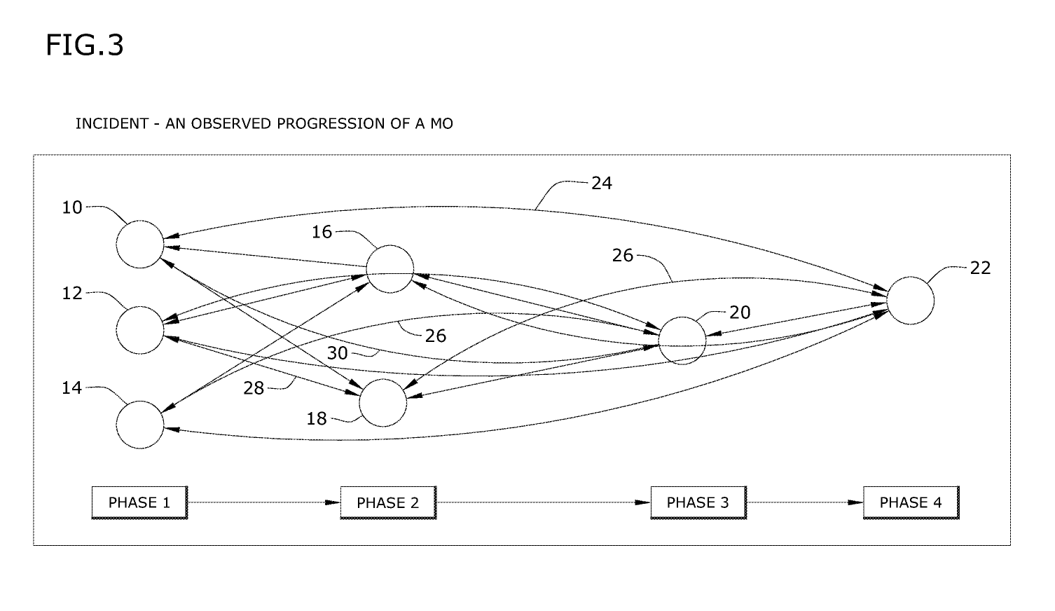

Referring next to the drawings, FIG. 3 is an illustrative diagram of a computer attack of a type that can be detected by various embodiments of the invention. In FIG. 3, nodes 10, 12, and 14 represent infected hosts—computers on which an attacker has installed malicious software to control them remotely. As discussed in the Background, the attacker sometimes accomplishes this by sending an e-mail containing a hyperlink to members of the targeted enterprise. When a user clicks on the hyperlink, the malicious software is installed on the user's machine. Phase 1 in FIG. 3 may thus be termed the “infection phase.”

Nodes 16 and 18 are staging hosts (computers inside the enterprise's network) that collect data from other computers on the network. Phase 2 in FIG. 3 may be termed the “collection phase.”

Node 20 is an exfiltration host, a server on the enterprise's network to which the staging hosts transmit the stolen data collected during Phase 2. Phase 3 in FIG. 3 may be termed the “staging phase.”

Node 22 is the exfiltration target, a computer controlled by the attacker that receives the data exfiltrated from the enterprise's network via exfiltration host 20. Phase 4 in FIG. 3 may be termed the “exfiltration phase.” The other numbered elements in FIG. 3 (24, 26, 28, and 30) represent connections (communications) that occur at various times among the nodes discussed above.

An attack such as that illustrated in FIG. 3 can be described as having a particular “modus operandi” (MO). The MO of a particular type of attack or attack scenario can be defined in terms of the entities or objects involved, the network connections among those entities or objects, and the order in which network connections are established during the various phases of the attack. Examples of entities or objects include hosts (client or server computers), user credentials (e.g., a user's username), and “files” (meaning, in the context of this description, malicious software objects or “malware”).

For a given MO, criteria can be derived that permit a “scraper” service on the enterprise network to categorize entities (host computers, user credentials, or files) into appropriate sets matching the MO in question. For example, a scraper might query an event data store for events involving infestations by a particular malicious software object (e.g., “Virus X”) and designate all affected host computers on the network as being members of a particular set. In other words, the MO criteria permit the scraper to identify the members of a set (e.g., “the set of all hosts on the network infected by Virus X”).

A scraper can then query a flow data store on the network (a source of information about communications that have taken place over the network, such as a network-communications log file obtained from a router or other network node) to define sets of network connections among the already-identified entities that match the MO. Analysis of the resulting sets of entities and network connections enables the system to determine that an attack matching the MO is currently underway. At that point, appropriate corrective action can be taken to thwart the attack.

In various embodiments, the system stores MOs corresponding to various attack scenarios in advance and provides criteria defining the sets of entities and connections for each MO to the scraper services. The MOs can be of a wide variety of types, including, without limitation, well-known industry-researched and published MOs, other historically-observed MOs, and hypothetical MOs (MOs of attacks not yet actually observed in practice).

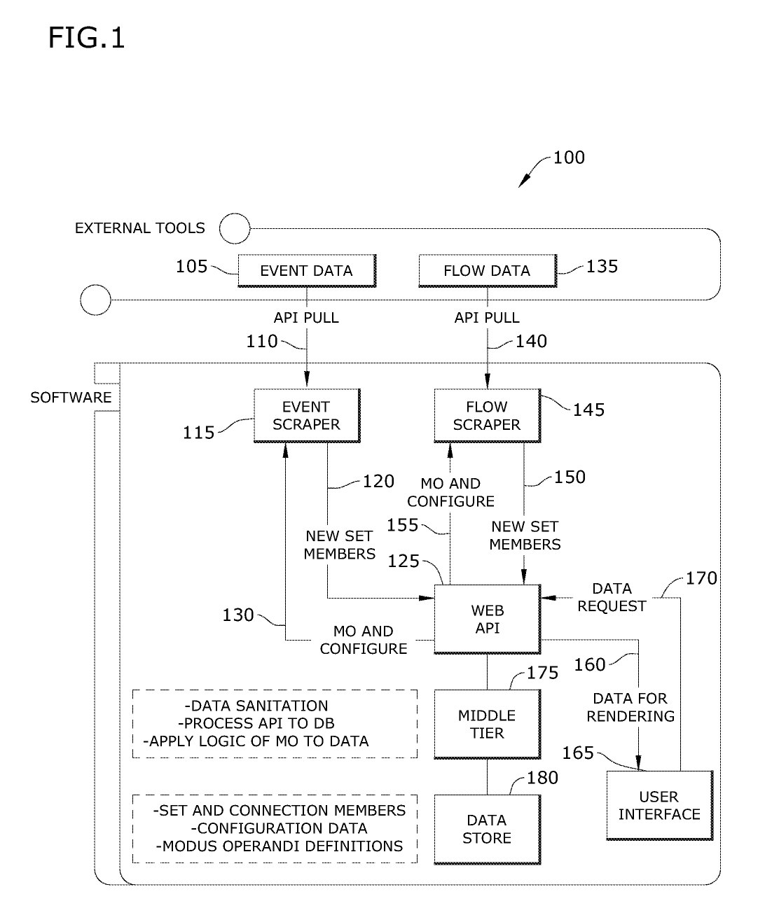

FIG. 1 is a functional block diagram of a system 100 for detecting computer attacks in accordance with an illustrative embodiment of the invention. In FIG. 1, a user can submit a data request (a request for a report of current network status) to user interface 165 via Web API 125. Web API 125 conveys the entity criteria associated with a MO from data store 180 to event scraper 115. Event scraper 115 queries event data store 105, via a suitable API 110, for event data matching the entity criteria of the MO. From the event data (e.g., “Computer A is infected with Virus X”), event scraper 115 identifies new set members (e.g., “Computer A,” “Virus X,” or an associated “username Y”) in accordance with the MO and communicates those set assignments to middle tier 175 and data store 180 via Web API 125. In extracting from the event data identifying information for a host computer, event scraper 115 may select, for example, the MAC address of the host computer.

Web API 125 conveys the connections criteria for the MO from data store 180 to flow scraper 145. Flow scraper 145 queries flow data store 135, via a suitable API 140, for network connections involving the identified entities that match the connections criteria of the MO. Connections matching the MO criteria are assigned to sets in accordance with the MO and are communicated to middle tier 175 via Web API 125.

Middle tier 175 analyzes the sets of entities and network connections identified by event scraper 115 and flow scraper 145 to determine whether an attack matching the MO is currently underway. If so, middle tier 175 transmits a notification via Web API 125 to user interface 165 or, in other embodiments, to a firewall appliance on the network.

In some embodiments, all of the functional blocks shown in FIG. 1 execute independently of one another. In some embodiments, the functional blocks (scrapers 115 and 145, middle tier 175, Web API 125, user interface 165, data store 180, and user interface 165) are implemented in software or firmware on a single server computer having one or more processing elements (e.g., microprocessors) and one or more memory elements (RAM, ROM, magnetic storage devices, optical storage devices, etc.). In such an embodiment, the server also includes one or more communication interfaces for communicating over a network with other computers. In other embodiments, the processing elements of the system are distributed among a plurality of server computers that are remotely located relative to one another. The memory elements and communication interfaces associated with the system, in such an embodiment, are likewise distributed among the plurality of server computers. In various embodiments, a plurality of program instructions stored in one or more memory elements cause the one or more processors, when the program instructions are executed, to perform the methods associated with the respective embodiments.

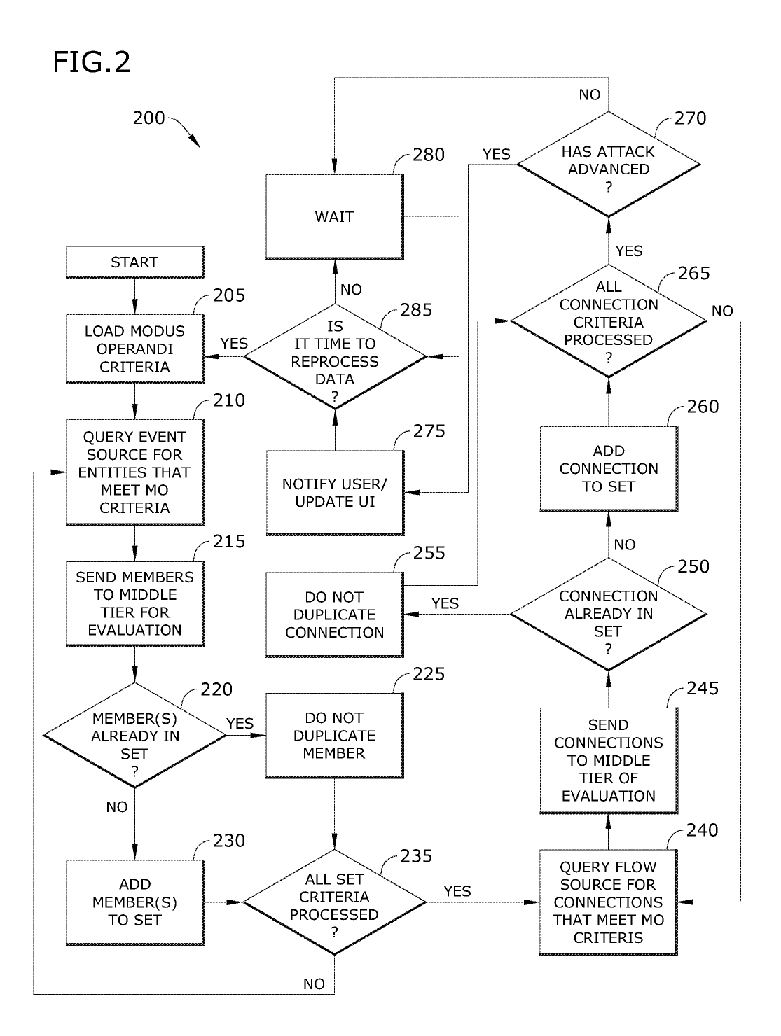

FIG. 2 is a flowchart of a method 200 for detecting computer attacks in accordance with an illustrative embodiment of the invention. The method commences at Block 205. At Block 205, entity-related MO criteria are loaded into one or more computer memories. Specifically, the entity-related MO criteria are transmitted to event scraper 115 via Web API 125, as discussed above. At Block 210, event scraper 115 queries event data store 105 for event data from which entities that meet the entity-related MO criteria can be identified. Event scraper 115, at Block 215, sends matching set-member entities (hosts, user credentials, or files) to middle tier 175 for evaluation. If the candidate set members are not already in the set at Decision Block 220, they are added at Block 230. If the candidate members are already in the set, they are not duplicated (Block 225). If more entity-related set criteria are yet to be processed at Decision Block 235, control returns to Block 210. If all entity-related set criteria have been processed at Decision Block 235, control passes to Block 240, at which flow scraper 145 queries flow data store 135 for network connections among the identified set-member entities that meet the connections-related MO criteria. At Block 245, flow scraper 145 sends any such network connections matching the MO criteria to middle tier 175 for evaluation. If those connections are already in the connections set at Decision Block 250, they are not duplicated (Block 255). Otherwise, they are added to the connections set at Block 260. If more connection-related MO criteria remain to be processed at Decision Block 265, control returns to Block 240. If all connection-related MO criteria have been processed at Decision Block 265, control passes to Decision Block 270, at which middle tier 175 determines, based on the identified set of entities and the identified set of network connections, whether a new attack is underway or an existing attack has advanced relative to a previous phase. If so, a notification is sent over the network via Web API 125 at Block 275. As discussed above, in some embodiments, the notification is sent to a user interface (e.g., a Web browser) associated with one or more users to notify one or more network administrators or other users of the new or advancing attack. If, at Decision Block 270, middle tier 175 determines that there is no attack underway or that an existing attack has not advanced relative to a previous phase, control proceeds to Block 280, a wait state that is maintained until it is time to once again process collected set data based on the MO criteria (Decision Block 285). Otherwise, control passes to Block 205, and the method is repeated beginning with the loading of entity-related MO criteria for use by event scraper 115.

The systems and methods described herein offer distinct advantages over prior-art computer-attack-detection systems. The inventive embodiments reduce the number of investigations that need to be performed because many separate events are related to one another combined into a single “incident.” Those embodiments also reduces the amount of time needed to perform the investigation because more relevant information is contained in the incident. The cumulative impact to an organization using the inventive approach is reduced number of investigations, reduced time per investigative cycle, and reduced risk caused by missing an intrusion attempt.

It should be understood that the foregoing relates to illustrative embodiments of the invention and that modifications may be made without departing from the spirit and scope of the invention as set forth in the following claims.

What is claimed is:

1. A system for detecting a computer attack, comprising:
at least one processor;
at least one memory;
at least one communication interface for communicating over a network; and
a plurality of program instructions stored in the at least one memory that, when executed by the at least one processor, cause the at least one processor to:
load into the at least one memory criteria for at least one modus operandi, each modus operandi corresponding to a particular attack scenario;
query an event data store to identify entities on the network that meet the criteria for the at least one modus operandi;
query a flow data store to identify network connections among the identified entities that meet the criteria for the at least one modus operandi;
analyze the identified entities and the identified network connections to determine whether an attack matching the at least one modus operandi is underway; and
transmit a notification over the network, if it is determined that an attack matching the at least one modus operandi is underway.

2. The system for detecting a computer attack of claim 1, wherein each identified entity is one of a host computer, a user credential, and a malicious software object.

3. The system for detecting a computer attack of claim 1, wherein the notification is transmitted to one or more computers on the network for the displaying of an alert in a Web browser.

4. The system for detecting a computer attack of claim 1, wherein the notification is transmitted to a network firewall.

5. The system for detecting a computer attack of claim 1, wherein the at least one processor, the at least one memory, the at least one communication interface, and the plurality of program instructions reside in a single server.

6. The system for detecting a computer attack of claim 1, wherein the at least one processor, the at least one memory, the at least one communication interface, and the plurality of program instructions are distributed among a plurality of servers that are remotely located with respect to one another.

7. A computer-implemented method for detecting a computer attack, comprising:
loading into a computer memory criteria for at least one modus operandi, each modus operandi corresponding to a particular attack scenario;
querying an event data store over a network to identify entities on the network that meet the criteria for the at least one modus operandi;
querying a flow data store over the network to identify network connections among the identified entities that meet the criteria for the at least one modus operandi;
analyzing the identified entities and the identified network connections to determine whether an attack matching the at least one modus operandi is underway; and
transmitting a notification over the network, if it is determined that an attack matching the at least one modus operandi is underway.

8. The computer-implemented method of claim 7, wherein each identified entity is one of a host computer, a user credential, and a malicious software object.

9. The computer-implemented method of claim 7, wherein the notification is transmitted to one or more computers on the network for the displaying of an alert in a Web browser.

10. The computer-implemented method of claim 7, wherein the notification is transmitted to a network firewall.
